(19) United States
(12) Patent Application Publication
(10) Pub. No.: US 2025/0053885 A1
(43) Pub. Date: Feb. 13, 2025

(54) Method and System Based on Using a Model Collection for Explanation of Machine Learning Results

(71) Applicant: ABB Schweiz AG, Baden (CH)

(72) Inventors: Benedikt Schmidt, Heidelberg (DE); Benjamin Kloepper, Mannheim (DE); Arzam Muzaffar Kotriwala, Ladenburg (DE); Yemao Man, Solna (SE); Dawid Ziobro, Västerås (SE); Gayathri Gopalakrishnan, Eskilstuna (SE); Joakim Astrom, Solna (SE); Marcel Dix, Allensbach (DE); Divyasheel Sharma, Bangalore (IN)

(73) Assignee: ABB Schweiz AG, Baden (CH)

(21) Appl. No.: 18/928,402

(22) Filed: Oct. 28, 2024

Related U.S. Application Data
(63) Continuation of application No. PCT/EP2022/061588, filed on Apr. 29, 2022.

(51) Int. Cl. G06N 20/20

(52) U.S. Cl. CPC G06N 20/20

(57) ABSTRACT

A method for explanation of machine learning results based on using a model collection includes training at least two machine learning models with at least two competing strategies for the at least one dataset; and using the least two machine learning models to yield at least two different predictions and/or at least two explanations for the at least one dataset.

### CROSS-REFERENCE TO RELATED APPLICATIONS

The instant application claims priority to International Patent Application No. PCT/EP2022/061588, filed Apr. 29, 2022, which is incorporated herein in its entirety by reference.

### FIELD OF THE DISCLOSURE

The present disclosure generally relates to a method and a system, which use a model collection for explanation of machine learning results.

### BACKGROUND OF THE INVENTION

The general background of this disclosure is explainable AI, ensemble learning, and advanced deep learning. Artificial intelligence models are increasing in popularity and are becoming more frequently used in industrial applications. To achieve desired machine learning model performance the models should be continuously updated to maintain desired performance across a longer time span. The continuous updates are necessary due to the dynamic conditions of industrial environments and machines which are continuously modified to meet customer requirements and business goals. As a consequence, model updates are often required to adjust model capabilities to conditions not covered in an earlier training phase of the model.

Successful adoption and application of machine learning in safety-critical domains requires justified results. Machine learning models which show high performance often are black-box models. For example, neural networks which have shown best-in-class performance for many AI challenges (e.g., image recognition) with decision criteria encoded in a complex mathematical formulation. Explainability has evolved as a technique to address limited evaluation of machine learning results. In case of neural networks, the root cause for taking a decision is made transparent by highlighting those components of the input data which are the reason for the result.

While machine learning (ML) with explainability is a powerful method supporting experts in evaluating the output of a model, they represent the decision root cause of one model. This is a tremendous improvement from a pure black-box model alone. Nevertheless, they do not show any alternative perspectives which might lead to other outputs. A method is required which allows a justified exploration of the result space and respective root causes to allow ML-based decision making. In fact, when there are “corner cases” where the ML model is also not necessarily “confident”/certain of its prediction, there is a need to make the domain expert aware of this to understand the limitation of the application of the model for the specific case and to take necessary informed action.

### BRIEF SUMMARY OF THE INVENTION

In one aspect, the present disclosure describes a method for explanation of machine learning results based on using a model collection is provided, the method comprising: training at least two machine learning models with at least two competing strategies for at least one dataset; and using at least two machine learning models to yield at least two different predictions and/or at least two explanations for the at least one dataset.

The intuition of the present disclosure is a panel of experts. The domain expert is supposed to consult the machine learning results just like a panel of experts. A panel of experts receives a problem description, then they consult and come to a conclusion. In the best case, the experts have different specializations to cover a broad range of potential explanations. If the result is unanimous, the panel gives the result to the seeker of advice. If the result is not unanimous, the panel not only provides the majority opinion, but indicates alternatives. For majority opinion and alternatives, the panel explains the rationale which would come to the respective conclusion.

The embodiments described herein translate the panel of experts to a collection of machine learning models with different specializations and the decision processing to a model voting with explainability features. A two-fold process is proposed which combines specialized model collections trained for a similar task with collection evaluation and contrastive explanation.

A contrastive explanation may clarify why an event occurred in contrast to another. The idea is—by providing outputs of more than one model, the user can be empowered to “consult” more models and explanations to weigh in different modelling perspectives, and justifications/explanations to better decide what action to take. This is in contrast to typical ML solutions whereby only a single ML output is presented to the user, irrespective of whether a single model was chosen from multiple candidates or if the output model is an ensemble of multiple models.

### BRIEF DESCRIPTION OF THE SEVERAL VIEWS OF THE DRAWING(S)

FIG. 1 illustrates a workflow for training, scoring and evaluating using model collections in accordance with the disclosure.

FIG. 2 illustrates an example for a multivariate time-series in accordance with the disclosure.

FIG. 3 illustrates an exemplary different model classification results for time-series, including the explanations in bounding boxes, in accordance with the disclosure.

### DETAILED DESCRIPTION OF THE INVENTION

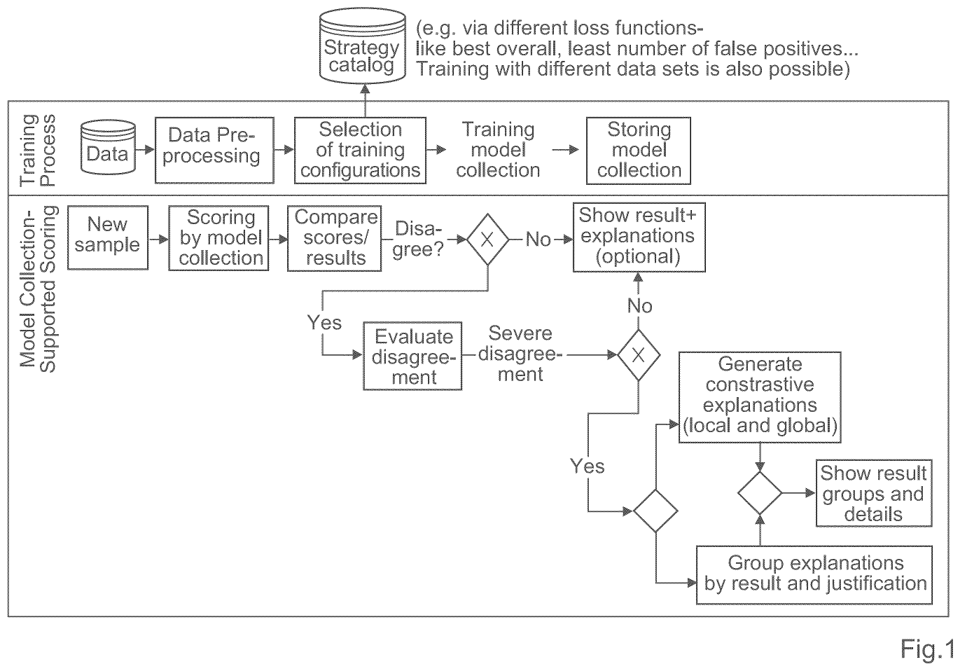

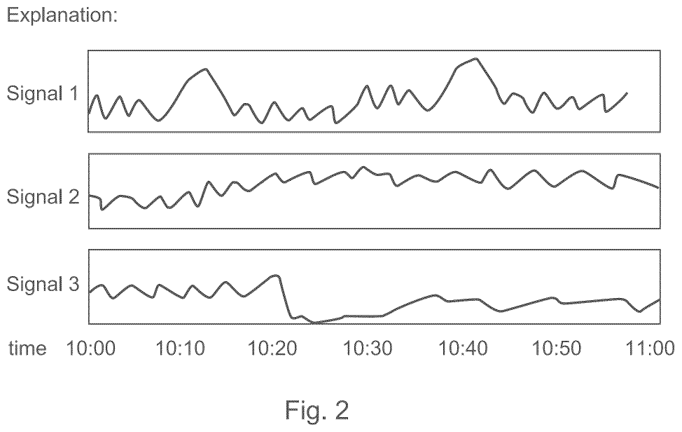

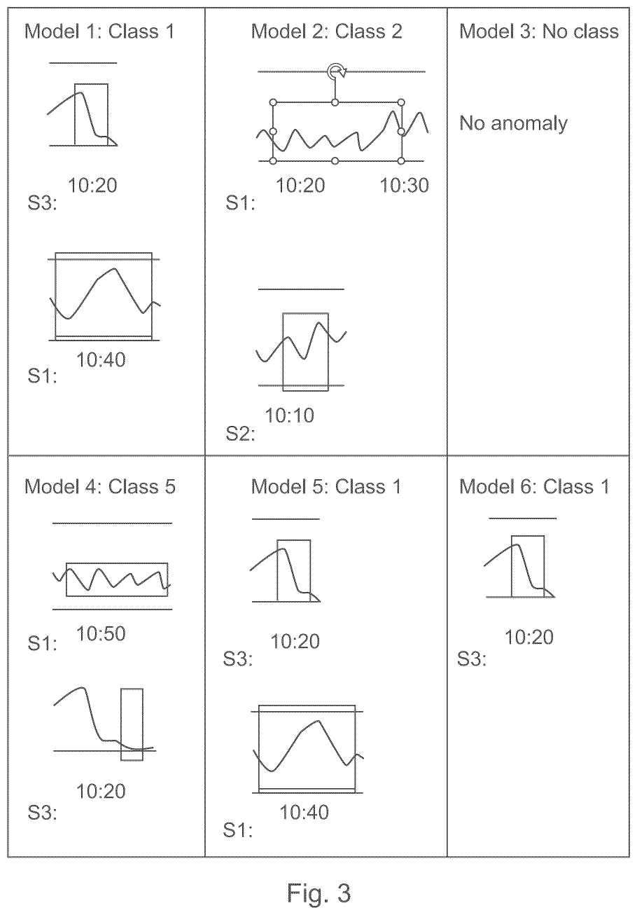

The following embodiments are mere examples for the method and the system disclosed herein and shall not be considered limiting. FIG. 1 illustrates a workflow for training, scoring and evaluating using model collections. FIG. 2 illustrates an example for a multivariate time-series. FIG. 3 illustrates an example different model classification results for time-series including the explanations in bounding boxes.

The present disclosure describes a method for explanation of machine learning results based on using a model collection is configured for providing outputs of more than one model, the user can be empowered to “consult” more models and explanations to weigh in different modelling perspectives, and justifications/explanations to better decide what action to take. The model collection is configured for using a specialized modelling according to an exemplary embodiment. According to an exemplary embodiment of the present disclosure, the method for explanation of machine learning results based on using a model collection is implemented by a decision process.

According to another exemplary embodiment of the present disclosure, the method for explanation of machine learning results based on using a model collection is implemented based on a contrastive explanation.

According to yet another exemplary embodiment of the present disclosure, the method for explanation of machine learning results based on using a model collection includes to train multiple models with competing strategies.

In an exemplary embodiment of the present disclosure, the method for explanation of machine learning results based on using a model collection includes evaluating the degree of (dis-) agreement between the model outputs for a specific data sample. According to an exemplary embodiment of the present disclosure, the method for explanation of machine learning results based on using a model collection includes generates contrastive explanations for the domain expert in case of noteworthy disagreement between the model outputs.

According to an exemplary embodiment of the present disclosure, the method for explanation of machine learning results based on using a model collection includes visually depicting to the user where and to what extent the model outputs agree and disagree.

According to an exemplary embodiment of the present disclosure, the method for explanation of machine learning results based on using a model collection includes calculating model agreement based on pre- and post-deployment model quality.

According to an exemplary embodiment of the present disclosure, the method for explanation of machine learning results based on using a model collection includes training multiple models with competing strategies for the same or multiple datasets.

According to an exemplary embodiment of the present disclosure, the method for explanation of machine learning results based on using a model collection includes using these different models to yield different predictions and/or explanations for the same data sample in question. This is specifically valuable for corner cut cases, i.e., data samples for which a single model may otherwise yield a prediction that is not confident or certain of (e.g., because the values of the data sample at hand does not entirely overlap with the range of values the model has been trained with).

FIG. 1 illustrates the evaluation workflow. In the following, the steps of the training and scoring processes are described.

Training process: At first, an input to the training process are one or more labelled data sets. The invention is not restricted to specific data types.

Secondly, the data pre-processing cleans and normalizes/standardizes the data in a form appropriate for machine learning. This includes steps like outlier removal, removing incomplete data or sampling. Thirdly, a strategy catalogue stores different model building strategies. A modelling strategy favors various aspects of the training. Examples are: via different loss functions-like best overall, training for least number of false positives, enforcing of training with specific feature groups, etc. Strategies are optimized for different data types. Therefore, the system selects based on aspects like type, structure, and size which strategies are used—this is the training configuration.

In a next step, the training model collection is generated using the training configuration. Here, a standard machine learning process is applied for every model. In a final step the trained models are stored for later use.

Model Collection—Supported Scoring: At first, an input to the process is a data sample which is of the same type as the data, the model collection has been trained with. Secondly, in a next step, every model of the model collection scores the sample. In other words, the sample is given as an input and the models generate their respective output. There is no combination of models—every model scores separately.

According to an exemplary embodiment of the present disclosure, whereby while there is no combination of the models, these individual models can themselves be ensembles of other models.

Thirdly, the result scores are compared to decide whether i) mutual agreement is given, ii) almost mutual agreement is given, iii) no agreement is given. Almost mutual agreement is given if there is only minor disagreement. This is decided by a rule (e.g., only one is different, only 10% are different, the least powerful models differ, etc.). If the system decides for almost mutual agreement it continues with the same steps like for mutual agreement.

### Mutual Agreement/Almost Mutual Agreement:

a. The system provides the scoring result—optional is an inspection of the result using standard Explainable AI techniques—can be realized with the same components used for model disagreement.

### Model Disagreement:

a. The system generates local and global contrastive explanations. This builds on model explainability. All types of explainability can be used (e.g. LIME, SHAP, Anchors, DiCE . . . ), contrastive explanations integrate mutual agreement and disagreement of multiple models in one representation. A local explanation only focuses on the scoring task at hand. The global explanation is based on the strategy used for training a model.

Local contrastive explanation: A simple form is an enumeration and ranking of the features the models have used for the same result and those features only few models selected. More advanced complex forms consider additional knowledge built up by the system over time.

Global contrastive explanation: A simple form is grouping models based on the aspects that they typically focus on. More advanced forms consider additional knowledge built up by the system over time.

b. A group explanation organizes the main directions the models propose separately. While the contrastive explanation gives insights by indicating similarities and differences from the features used for reasoning, the group explanation focuses on the model results. Organization happens purely result based-bringing those models together which come up with similar results. Here explanation features are also used per group, but only to show the distribution of features used to come to the result presentation.

c. Contrastive and group explanation are provided to the user. They can be used by an application in various forms to present the data to the user. In text form, or in form of visualizations which highlight different aspects of the data.

Training of multiple models with competing strategies for the same dataset.

The idea is to train multiple models with competing strategies for the same dataset i.e. to ‘force’ different models to learn different concepts. This could be achieved in different ways. The following examples can be combined:
i) Training each model using a different subset of data;
ii) The subsets could be chosen in a way such that the distance of the data samples between subsets is maximized and the distance between the samples within a subset is minimized e.g. using (K-Means) clustering approach; or
iii) The subsets could be chosen in a way such that each subset represents different context or operation type (e.g. steady state vs. transition) based on some metadata.

Training each model using a different loss function.

For instance, a model where the (R)MSE is optimized, the model would be penalized for making larger errors (due to squaring of the errors). On the other hand, a model where the MA(P)E is optimized, the model would be less sensitive to outliers better. In a more general form, each model can be trained with different data. Models are trained for a specific data type, but they still can be trained with different models.

In this case model agreement is the exception—the models will present results from different domains with different labels. It is up to the human expert to decide for the most reasonable classification.

In the following, an example with industrial time-series data shall be used to provide further intuition for the core of this disclosure—the generation of a model collection. In FIG. 2 an example for sensor signals is provided. For the example, signal 1 can be considered as a level value of a liquid in a tank, signal 2 an indicator for flow in a pipe connected to the tank and signal 3 an indicator for temperature.

The machine learning models are trained to spot different types of process anomalies. In total, they are trained on 20 common process anomalies. The training process for the models has forced them to focus on different features. While some focus on variation in the data, others have been trained on gradients, others specifically focus on change points. The respective scoring process with related explanation will only take these aspects into and account.

It may not be trivial to determine what constitutes disagreement between competing models i.e., what should the threshold of disagreement between models be in order to reveal outputs of competitive models to the user.

Model quality information supports the model agreement decision. Next to the basic form which assesses the number of agreements or disagreement quality information can be taken into account. If models with high quality agree while models with low quality disagree, this might still be considered an agreement. In other words, an agreement function can be implemented which takes model quality into account.

Model quality can have at least two sources: First, pre-deployment quality which is derived from the model quality in the training process—the performance the model showed on a dataset in the training phase. One possibility is to use a ML performance metric (e.g., RMSE, accuracy or F1-Score) across different models for the same historical data to rank the models. Consequently, models with higher rank would have greater influence on the disagreement score. Second, post-deployment quality. Whenever the system is used, a user selects a result. In cases of model disagreement, the score of one or many models is favored against the score of other models. Every time this happens global knowledge about the models can be collected which can be used for 1) deciding model agreement/disagreement, 2) for generating local/global contrastive explanations.

Generation of contrastive explanations and group explanations for domain expert in case of noteworthy disagreement between model outputs: In case of noteworthy disagreement between model outputs, the following types of explanations are provided:
Global explanation: to inform an expert of general reasoning, rules, or behavior the model uses global explanations to make predictions e.g., which features does this model consider important or inform the user that this model has been optimized to minimize extreme predictions at the cost of yielding more averaged predictions.
Local explanation: to inform expert of how each model treats the same data point differently to yield a different result. Local explanations use an explainability mechanism (e.g., LIME, SHAP, Anchors, DiCE, or any further mechanism). The mechanism hints to the role of different pieces of the input data for the decision mechanism. Contrastive explanation compares the relevance of input data sections for the different models. Goal is to highlight sections of agreement and disagreement of model groups.

Presentation of Explanations: According to an exemplary embodiment of the present invention two different presentations of explanations: “contrastive explanations” provide a general overview of all model outputs and highlight agreement and disagreement. “Group explanations” group models based on similar output and highlight only for respective groups how they agree and disagree. Visual depiction of where and to what extent the model outputs agree and disagree. For contrastive explanations as well as for general result presentation visualizations can be used which highlight core components.

In FIG. 3 the scoring of the time-series window of the figure is shown. For six models the issue classification of the time window is shown. Models 1, 5, 6 propose class 1. Model 2 proposes class 2. Model 3 does not spot issues and does not return a class. Model 4 proposes class 5. The information shows a strong tendency towards class 1.

In the claims as well as in the description the word “comprising” does not exclude other elements or steps and the indefinite article “a” or “an” does not exclude a plurality. A single element or other unit may fulfil the functions of several entities or items recited in the claims. The mere fact that certain measures are recited in the mutual different dependent claims does not indicate that a combination of these measures cannot be used in an advantageous implementation.

In an embodiment of the method for explanation of machine learning results based on using a model collection, at least one machine learning model of the at least two machine learning models is a specialized machine learning model, which is adapted to a certain task.

In an embodiment of the method for explanation of machine learning results based on using a model collection, the method further comprises the step of comparing the at least two different predictions and/or at least two explanations and selecting at least one machine learning model of the at least two machine learning models based on the comparison.

In an embodiment of the method for explanation of machine learning results based on using a model collection, at least one explanation of the at least two explanations is a contrastive explanation relative at least one contrast case.

In an embodiment of the method for explanation of machine learning results based on using a model collection, the method further comprises the step of evaluating a degree of disagreement between the at least two different predictions and/or at least two explanations for the at least one dataset.

In an embodiment of the method for explanation of machine learning results based on using a model collection, the method further comprises the step of generating contrastive explanations for the domain expert in case of noteworthy disagreement between the model outputs.

In an embodiment of the method for explanation of machine learning results based on using a model collection, the method further comprises the step of visually depicting to a user an agreement-extent according to which the least two different predictions and/or at least two explanations for the at least one dataset agree.

In an embodiment of the method for explanation of machine learning results based on using a model collection, the method further comprises the step of visually depicting to a user a disagreement-extent according to which the least two different predictions and/or at least two explanations for the at least one dataset disagree.

In an embodiment of the method for explanation of machine learning results based on using a model collection, the method further comprises the step of calculating a model agreement based on pre-deployment model quality of the least two different predictions and/or at least two explanations.

In an embodiment of the method for explanation of machine learning results based on using a model collection, the method further comprises the step of calculating a model agreement based on post deployment model quality of the least two different predictions and/or at least two explanations.

In an embodiment of the method for explanation of machine learning results based on using a model collection, the method further comprises the step of using a strategy catalog storing different model building strategies for generating the at least two competing strategies.

In an embodiment of the method for explanation of machine learning results based on using a model collection, the different model building strategies are based on a difference in favoring of at least one parameter of the training of the at least two machine learning models.

In an embodiment of the method for explanation of machine learning results based on using a model collection, the different model building strategies are based a difference with regard to at least one optimization criteria used during the training of the at least two machine learning models.

In one aspect of the disclosure a system for explanation of machine learning results based on using a model collection is presented, the system comprising a processor for executing the method according to the first aspect.

Any disclosure and embodiments described herein relate to the method and the system, lined out above and vice versa. Advantageously, the benefits provided by any of the embodiments and examples equally apply to all other embodiments and examples and vice versa.

As used herein “determining” also includes “initiating or causing to determine,” “generating” also includes “initiating or causing to generate” and “providing” also includes “initiating or causing to determine, generate, select, send or receive”. “Initiating or causing to perform an action” includes any processing signal that triggers a computing device to perform the respective action.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for explanation of machine learning results based on using a model collection, the method comprising:
training at least two machine learning models with at least two competing strategies for at least one dataset; and
using the least two machine learning models to yield at least two different predictions and/or at least two explanations for the at least one dataset.

2. The method according to claim 1, wherein at least one machine learning model of the at least two machine learning models is a specialized machine learning model that is adapted to a certain task.

3. The method according to claim 1, wherein the method further comprises comparing the at least two different predictions and/or at least two explanations, and selecting at least one machine learning model of the at least two machine learning models based on the comparison.

4. The method according to claim 1, wherein at least one explanation of the at least two explanations is a contrastive explanation relative at least one contrast case.

5. The method according to claim 1, wherein the method further comprises evaluating a degree of disagreement between the at least two different predictions and/or at least two explanations for the at least one dataset.

6. The method according to claim 1, further comprising the step of generating contrastive explanations for the domain expert in case of noteworthy disagreement between the model outputs.

7. The method according to claim 1, further comprising the step of visually depicting to a user an agreement-extent according to which the least two different predictions and/or at least two explanations for the at least one dataset agree.

8. The method according to claim 1, further comprising visually depicting to a user an disagreement-extent according to which the least two different predictions and/or at least two explanations for the at least one dataset disagree.

9. The method according to claim 1, further comprising calculating a model agreement based on pre-deployment model quality of the least two different predictions and/or at least two explanations.

10. The method according to claim 1, further comprising calculating a model agreement based on post deployment model quality of the least two different predictions and/or at least two explanations.

11. The method according to claim 1, further comprising using a strategy catalog storing different model building strategies for generating the at least two competing strategies.

12. The method according to claim 11, wherein the different model building strategies are based on a difference in favoring of at least one parameter of the training of the at least two machine learning models.

13. The method according to claim 11, wherein the different model building strategies are based a difference with regard to at least one optimization criteria used during the training of the at least two machine learning models.
